(19) United States
(12) Patent Application Publication
(10) Pub. No.: US 2025/0177240 A1
(43) Pub. Date: Jun. 5, 2025

(54) EXPANDABLE AND CONTRACTIBLE STRUCTURE FOR MASSAGE DEVICE AND MASSAGE DEVICE

(71) Applicant: ENVY Health Technology (Dongguan) Co., Ltd., Guangdong (CN)

(72) Inventors: ZHI-PING TU, Guangdong (CN); XIONG XIAO, Guangdong (CN)

(21) Appl. No.: 18/411,474

(22) Filed: Jan. 12, 2024

(30) Foreign Application Priority Data
Dec. 5, 2023 (CN) 202323314558.0

(51) Int. Cl. A61H 21/00

(52) U.S. Cl. CPC A61H 21/00

(57) ABSTRACT

The present invention relates to an expandable and contractible structure for a massage device and a massage device, comprising a geared motor, a transmission mechanism, an expandable and contractible mechanism, and a casing. The expandable and contractible mechanism comprises a fan blade fixture, an expansion driver, and deformable fan blades. The transmission mechanism is disposed at the power output end of the geared motor, the expansion driver is sleeved on the transmission mechanism, and the geared motor is accommodated in the casing, which drives the expansion driver and facilitates the opening of the fan blades. When the motor reverses, the expansion driver resets, causing the blades to contract under elastic stress. This design ensures a smooth, jam-free operation and greatly enhances the user experience with its distinctive expandable and contractible functionality.

### FIELD OF INVENTION

The present invention relates to the field of massage device, in particular to an expandable and contractible structure for a massage device.

### BACKGROUND OF THE INVENTION

In today's demanding work and life environment, prolonged exposure often leads to decreased energy, muscle tension, and soreness. Many choose massage as a means of physical and mental relaxation. Massage sticks or fitness wands are commonly used to tap on body parts to relax muscles and promote blood circulation. However, most fitness wands on the market have limitations: hand-held rehabilitation products cannot effectively massage or tap other areas of the body, and their long-term effectiveness tends to plateau without significant improvement. In addition, in the realm of pleasure massagers, current products primarily rely on rotational or vibrational mechanisms and lack expandable and contractible features, thus failing to meet users' needs.

### SUMMARY OF THE INVENTION

To overcome the limitations and deficiencies of the prior art, the purpose of the present invention is to provide a unique and novel expandable and contractible structure for a massage device. This structure is driven by a geared motor to activate a transmission mechanism which in turn moves an expansion driver. The expansion driver then causes cylindrically arranged deformable fan blades to open. When reversing, the geared motor resets the expansion driver and the deformable fan blades contract under elastic stress. This repeated expansion and contraction not only enables the continuous expansion and contraction function of the massage device, but also, due to the structure, is compact and works smoothly without jamming, providing a better user experience.

Another purpose of the present invention is to provide a massage device with a simple and novel structure, capable of relaxing muscles in various areas and alleviating tension and soreness. Its expandable and contractible feature not only enhances pleasure, but can also be used in health products for exercising the prostate.

The present invention achieves its purposes through the following technical solutions: An expandable and contractible structure for a massage device, comprising a geared motor, a transmission mechanism, an expandable and contractible mechanism, and a casing. The expandable and contractible mechanism comprises a fan blade fixture, an expansion driver, and multiple deformable fan blades. The transmission mechanism is disposed at the power output end of the geared motor. One end of the deformable fan blades is fixed to the end of the geared motor by the fan blade fixture, with the deformable fan blades being arranged cylindrically. The expansion driver is sleeved on the transmission mechanism and can push the deformable fan blades to open. The geared motor is accommodated in the casing with its power output end extending out of the casing.

Preferably, the number of the deformable fan blades is six.

Further, the inner side of the deformable fan blades is provided with arcuate guide rails. The sidewall of the upper end of the expansion driver is provided with multiple of upwardly and inwardly inclined guide grooves corresponding to the arcuate guide rails, and the arcuate guide rail of each deformable fan blade engages with the corresponding guide groove.

Further, the inner side of the deformable fan blades is provided with inclined guide rails. The rail surface of the inclined guide rails is designed to be inclined upwardly and inwardly, and the sidewall of the upper end of the expansion driver is provided with multiple guide grooves that are also inclined upwardly and inwardly, corresponding to the inclined guide rails, and the inclined guide rail of each deformable fan blade engages with the corresponding guide groove.

Further, the transmission mechanism comprises a rotational guide rail, a limit seat, a steel ball, and a fixed plate. The outer sidewall of the rotational guide rail has a spiral upward groove. One end of the rotational guide rail is fixed to a rotating shaft of the geared motor. The sidewall of the limit seat corresponding to the fixed plate has a limit opening extending upward, and the rotational guide rail is sleeved within the limit seat, with a lower end of the limit seat fixed to the end of the geared motor. The steel ball is embedded in the groove and contacts one side of the fixed plate.

Further, the sidewall of the expansion driver corresponding to the fixed plate is provided with a slot, and the fixed plate is embedded in the slot. A round hole corresponding to the steel ball is provided in the slot, and one side of the steel ball passes through the round hole and contacts the fixed plate.

Further, the casing also houses an electrical main body located on one side of the geared motor. The electrical main body includes a battery, a PCBA board, and a charging module. The battery, the charging module, and the PCBA board are installed within the casing, and the geared motor, the charging module, and the battery all are electrically connected to the PCBA board.

Further, the bottom of the casing is also equipped with a button.

Further, the casing includes a first casing and a second casing that interlocks with each other.

A massage device comprising a silicone sleeve, a first vibration motor, a second vibration motor, and the aforementioned expandable and contractible structure. The expandable and contractible structure is sleeved within the silicone sleeve, and the first vibration motor is disposed at one end within the silicone sleeve, while the second vibration motor is disposed at the other end.

The beneficial effects of the present invention include:

1. The unique and novel expandable and contractible structure for the massage device is driven by the geared motor to activate the transmission mechanism, which in turn moves the expansion driver. The expansion driver then causes cylindrically arranged deformable fan blades to open. When reversing, the geared motor resets the expansion driver and the deformable fan blades contract under elastic stress. This repeated expansion and contraction not only enables the continuous expansion and contraction function of the massage device, but also, due to the structure, is compact and works smoothly without jamming, providing a better user experience.

2. The massage device with the built-in expandable and contractible structure has a simple and novel design, capable of relaxing muscles in various areas and alleviating tension and soreness. Its expandable and contractible feature not only enhances pleasure, but can also be used in health products for exercising the prostate.

### BRIEF DESCRIPTION OF THE DRAWINGS

FIG. 1 is a three-dimensional view of the expandable and contractible structure in Embodiment 1 of the present invention;

FIG. 2 is a cross-sectional view of the expandable and contractible structure in Embodiment 1 of the present invention;

FIG. 3 is a schematic of a partial exploded view of the expandable and contractible structure in Embodiment 1 of the present invention;

FIG. 4 is a schematic of an exploded view of the expandable and contractible structure in Embodiment 1 of the present invention;

FIG. 5 is a schematic of an exploded view of the transmission mechanism and expandable and contractible mechanism of the expandable and contractible structure in Embodiment 1 of the present invention;

FIG. 6 is a three-dimensional view of the massage device in Embodiment 1 of the present invention;

FIG. 7 is a cross-sectional view of the massage device in Embodiment 1 of the present invention;

FIG. 8 is a schematic of a partial exploded view of the expandable and contractible structure in Embodiment 2 of the present invention; and

FIG. 9 is a schematic of a partial exploded view of the expandable and contractible mechanism in Embodiment 2 of the present invention.

### DETAILED DESCRIPTION OF THE PREFERRED EMBODIMENTS

For the better understanding of those skilled in the art, the present invention will be further described in conjunction with the embodiments and accompanying drawings 1 to 9. The content referenced in the embodiments is not a limitation of the present invention.

### Embodiment 1

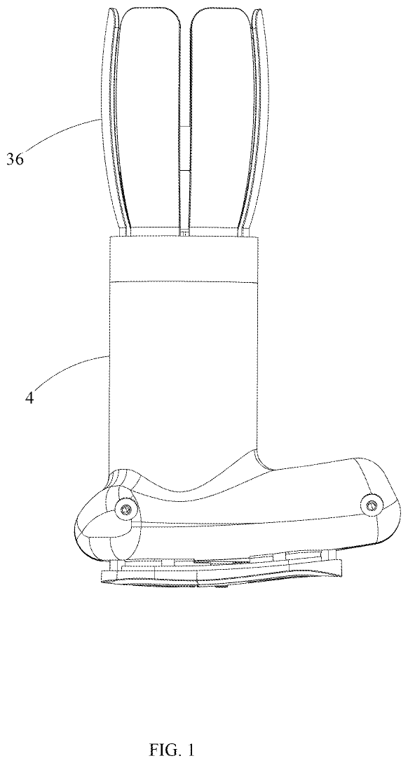

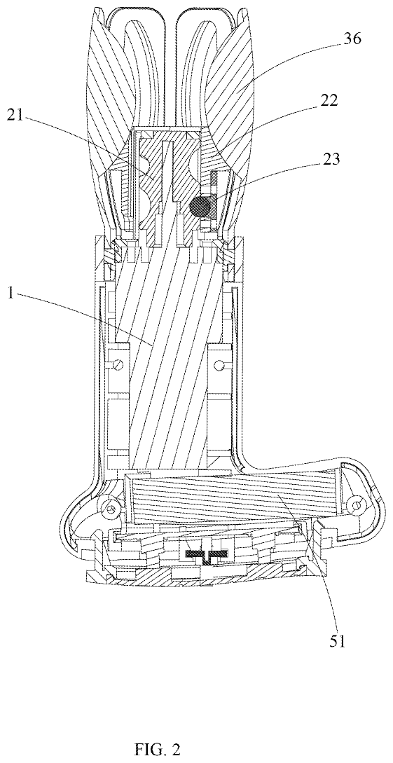

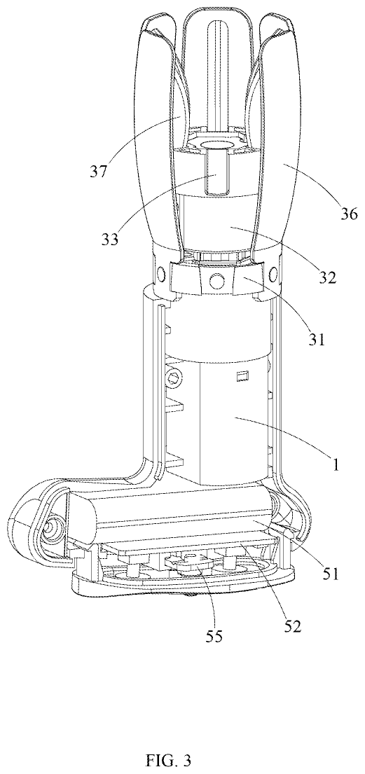

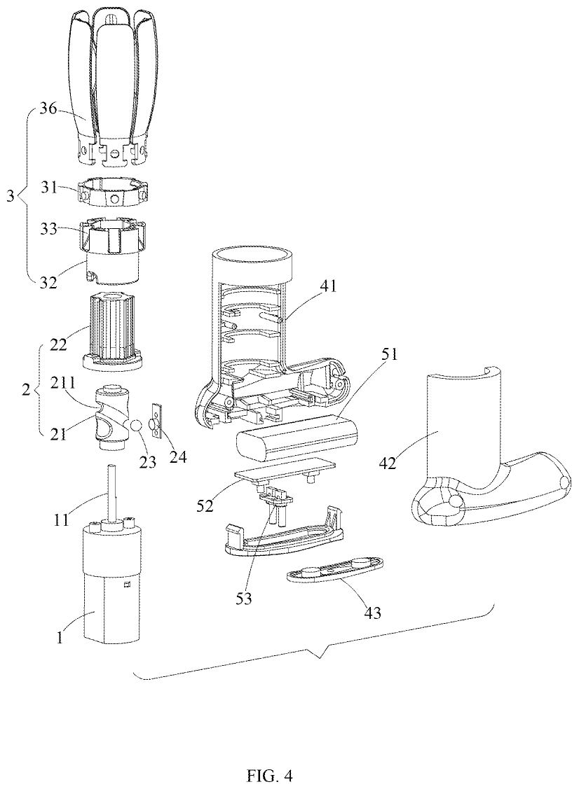

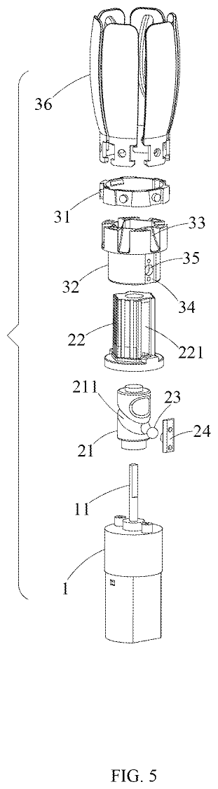

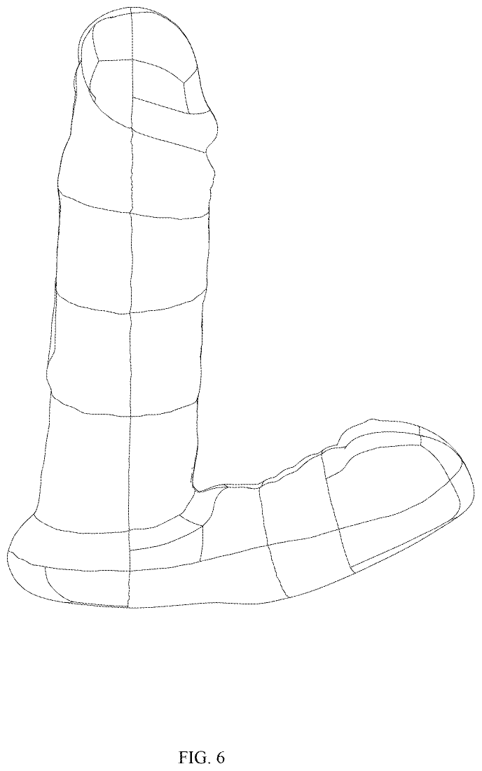

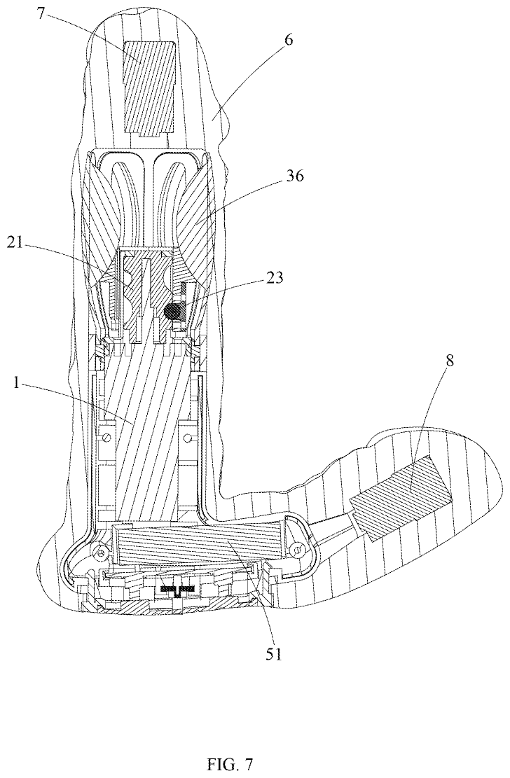

Refer to FIGS. 1 to 7, an expandable and contractible structure for a massage device comprises a geared motor 1, a transmission mechanism 2, an expandable and contractible mechanism 3, and a casing 4. The expandable and contractible mechanism 3 comprises a fan blade fixture 31, an expansion driver 32, and six deformable fan blades 36. The transmission mechanism 2 is disposed at the power output end of the geared motor 1. One end of the deformable fan blades 36 is fixed to the end of the geared motor 1 by the fan blade fixture 31, with the deformable fan blades 36 being arranged cylindrically. The expansion driver 32 is sleeved on the transmission mechanism 2 and can push the deformable fan blades 36 to open. The geared motor 1 is accommodated in the casing 4 with a power output end of the geared motor 1 extending out of the casing 4.

In this embodiment, the inner side of the deformable fan blades 36 is provided with arcuate guide rails 37. The sidewall of the upper end of the expansion driver 32 is provided with multiple upwardly and inwardly inclined guide grooves 33 corresponding to the arcuate guide rails 37, and the arcuate guide rail 37 of each deformable fan blade engages with the corresponding guide groove 33.

The expandable and contractible structure for the massage device in this embodiment is unique and novel, which is driven by a geared motor 1 to activate a transmission mechanism 2 which in turn moves an expansion driver 32. This movement causes the cylindrically arranged deformable fan blades 36 to open to their maximum extent when the guide grooves 33 of the expansion driver 32 slide up along the arcuate guide rails 37 to their highest points to achieve an expansion effect. When reversing, the geared motor 1 resets the expansion driver 32 and the deformable fan blades 36 contract under elastic stress. This repeated expansion and contraction not only enables the continuous expansion and contraction function of the massage device, but also, due to the structure, is compact and works smoothly without jamming, providing a better user experience.

In this embodiment, the transmission mechanism 2 comprises a rotational guide rail 21, a limit seat 22, a steel ball 23, and a fixed plate 24. The outer sidewall of the rotational guide rail 21 has a spiral upward groove 211. One end of the rotational guide rail 21 is fixed to a rotating shaft 11 of the geared motor 1, and the sidewall of the limit seat 22 corresponding to the fixed plate 24 has a limit opening 221 extending upward. The rotational guide rail 21 is sleeved within the limit seat 22, with a lower end of the limit seat 22 fixed to the end of the geared motor 1. The steel ball 23 is embedded in the groove 211 and contacts one side of the fixed plate 24.

In this embodiment, the sidewall of the expansion driver 32 corresponding to the fixed plate 24 is provided with a slot 34, and the fixed plate 24 is embedded in the slot 34. A round hole 35 corresponding to the steel ball 23 is provided in the slot 34, and one side of the steel ball 23 passes through the round hole 35 and contacts the fixed plate 24. This arrangement facilitates the fixation of the expansion driver 32 to the fixed plate 24, enabling the geared motor 1 to drive the up and down reciprocating motion of the expansion driver 32.

When the geared motor 1 drives the transmission mechanism 2, the geared motor 1 first causes the rotational guide rail 21 to rotate within the limit seat 22. The rotation of the rotational guide rail 21 moves the steel ball 23 embedded in the groove 211 upward, while simultaneously moving the fixed plate 24 in contact with the steel ball 23. This movement drives the expansion driver 32, bringing it to its highest point when the steel ball 23 reaches the top of the groove 211. At that moment, the guide grooves 33 of the expansion driver 32 slide along the arcuate guide rails 37 to their highest points, causing the deformable fan blades 36 to open to their maximum extent to achieve the expansion effect. When reversing, the geared motor 1 resets the expansion driver 32 and the deformable fan blades 36 contract under elastic stress. This repeated expansion and contraction not only enables the continuous expansion and contraction function of the massage device, but also, due to the structure, is compact and works smoothly without jamming, providing a better user experience.

In this embodiment, the casing 4 also houses an electrical main body located on one side of the geared motor 1. The electrical main body includes a battery 51, a PCBA board 52, and a charging module 53. The battery 51, the charging module 53, and the PCBA board 52 are installed within the casing 4, and the geared motor 1, the charging module 53, and the battery 51 all are electrically connected to the PCBA board 52.

In this embodiment, the bottom of the casing 4 is also equipped with a button 43.

In this embodiment, the casing 4 includes a first 41 casing and a second 42 casing that interlocks with each other to facilitate the installation or maintenance of internal components.

A massage device comprising a silicone sleeve 6, a first vibration motor 7, a second vibration motor 8, and the aforementioned expandable and contractible structure. The expandable and contractible structure is sleeved within the silicone sleeve 6, and the first vibration motor 7 is disposed at one end within the silicone sleeve 6, while the second vibration motor 8 is disposed at another end. The use of the first vibration motor 7 and the second vibration motor 8 further enhances the massage effect. The structure of the massage device is simple and novel, capable of relaxing muscles in various areas and alleviating tension and soreness. It also adds pleasure through expansion and contraction, and can be used in health products to exercise the prostate.

### Embodiment 2

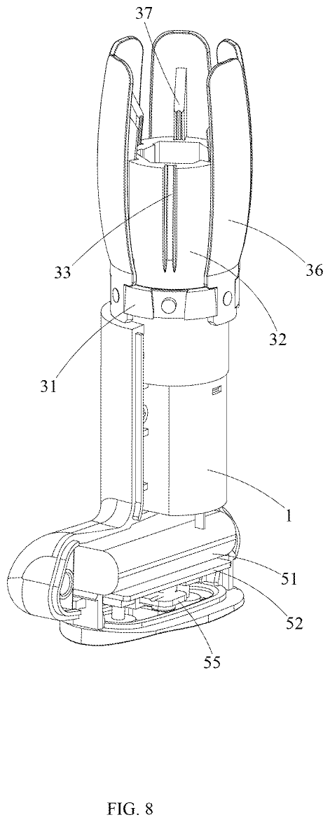

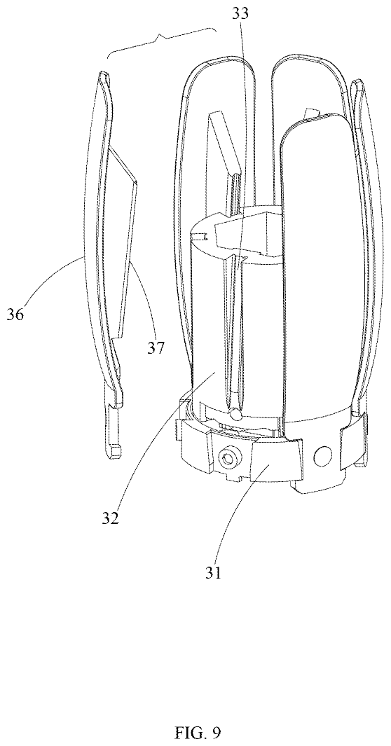

With reference to FIGS. 8 and 9, the difference in this embodiment from Embodiment 1 is that in this embodiment, the inner side of the deformable fan blades 36 is provided with inclined guide rails 37. The rail surface of the inclined guide rails 37 is designed to be inclined upward and inward, and the sidewall of the upper end of the expansion driver 32 is provided with multiple guide grooves 33 that are also inclined upward and inward corresponding to the inclined guide rails 37, with the inclined guide rail 37 of each deformable fan blade engaging with the corresponding guide groove 33. The remaining contents of this embodiment are the same as in Embodiment 1 and will not be repeated here.

In this embodiment, when the geared motor 1 drives the rotational guide rail 21, the rotational guide rail 21 rotates within the limit seat 22. The rotation of the rotational guide rail 21 moves the steel ball 23 embedded in the groove 211 upward, while simultaneously moving the fixed plate 24 in contact with the steel ball 23. This movement drives the expansion driver 32, bringing it to its highest point when the steel ball 23 reaches the top of the groove 211. At that moment, the guide grooves 33 of the expansion driver 32 slide along the inclined guide rails 37 to their highest points, causing the deformable fan blades 36 to open to their maximum extent to achieve the expansion effect.

The foregoing embodiments are preferred embodiments of the present invention. In addition, the present invention may be implemented in other ways. Any obvious substitutions made without departing from the concept of the present invention will fall within the scope of protection of the present invention.

What is claimed is:

1. An expandable and contractible structure for a massage device comprising a geared motor, a transmission mechanism, an expandable and contractible mechanism, and a casing, wherein the expandable and contractible mechanism comprises a fan blade fixture, an expansion driver, and multiple deformable fan blades; the transmission mechanism is disposed at an power output end of the geared motor, one end of the deformable fan blades is fixed to the end of the geared motor by the fan blade fixture, with the deformable fan blades being arranged cylindrically; and the expansion driver is sleeved on the transmission mechanism and is capable of pushing the deformable fan blades to open, and the geared motor is accommodated within the casing with the power output end of the geared motor extending out of the casing.

2. The expandable and contractible structure for a massage device according to claim 1, wherein the inner side of the deformable fan blades is provided with arcuate guide rails, and the sidewall of the upper end of the expansion driver is provided with multiple upwardly and inwardly inclined guide grooves corresponding to the arcuate guide rails, and the arcuate guide rail of each deformable fan blade engages with the corresponding guide groove.

3. The expandable and contractible structure for a massage device according to claim 1, wherein the inner side of the deformable fan blades is provided with inclined guide rails, and the rail surface of the inclined guide rails is designed to be inclined upwardly and inwardly, and the sidewall of the upper end of the expansion driver is provided with multiple guide grooves that are also inclined upwardly and inwardly and correspond to the inclined guide rails, and the inclined guide rail of each deformable fan blade engages with the corresponding guide groove.

4. The expandable and contractible structure for a massage device according to claim 1, wherein the transmission mechanism comprises a rotational guide rail, a limit seat, a steel ball, and a fixed plate, wherein the outer sidewall of the rotational guide rail has a spiraling upward groove, one end of the rotational guide rail is fixed to a rotating shaft of the geared motor, and the sidewall of the limit seat corresponding to the fixed plate has an upward-extending limit opening, and the rotational guide rail is sleeved within the limit seat, with a lower end of the limit seat fixed to the end of the geared motor, and the steel ball is embedded in the groove and contacts one side of the fixed plate.

5. The expandable and contractible structure for a massage device according to claim 4, wherein the sidewall of the expansion driver corresponding to the fixed plate is provided with a slot, and the fixed plate is embedded within the slot, and the slot corresponding to the steel ball is provided with a round hole, and one side of the steel ball passes through the round hole and contacts the fixed plate.

6. The expandable and contractible structure for a massage device according to claim 1, wherein the casing houses an electrical main body located on one side of the geared motor, the electrical main body comprises a battery, a PCBA board, and a charging module, wherein the battery, the charging module, and the PCBA board are installed within the casing, and the geared motor, the charging module, and the battery all are electrically connected to the PCBA board.

7. The expandable and contractible structure for a massage device according to claim 1, wherein the bottom of the casing is equipped with a button.

8. The expandable and contractible structure for a massage device according to claim 1, wherein the casing includes a first casing and a second casing that interlocks with each other.

9. A massage device comprising a silicone sleeve, a first vibration motor, a second vibration motor, and the expandable and contractible structure, wherein the expandable and contractible structure is sleeved within the silicone sleeve, and the first vibration motor is disposed at one end within the silicone sleeve, while the second vibration motor is disposed at another end.
